(19) United States
(12) Patent Application Publication
(10) Pub. No.: US 2025/0091334 A1
(43) Pub. Date: Mar. 20, 2025

(54) PAPER-BASED RECYCLABLE INSULATED BAGS

(71) Applicant: PROAMPAC HOLDINGS INC., Cincinnati, OH (US)

(72) Inventors: Seyed Hesamoddin Tabatabaei, Mason, OH (US); Amir Saffar, Laval (CA); Raymond J. Recchia, Cincinnati, OH (US); James E. Tierney, South Hadley, MA (US); Terry J. Leis, Huntington, MA (US)

(21) Appl. No.: 18/882,048

(22) Filed: Sep. 11, 2024

Related U.S. Application Data
(60) Provisional application No. 63/538,543, filed on Sep. 15, 2023.

(51) Int. Cl. B32B 27/10; B31B 70/16; B31B 160/20; B31B 170/20; B32B 7/12; B32B 15/12; B32B 37/12; B65D 30/08

(52) U.S. Cl. CPC B32B 27/10; B31B 70/16; B32B 7/12; B32B 15/12; B32B 37/12; B65D 31/02; B31B 2160/20; B31B 2170/20; B32B 2255/10; B32B 2255/205; B32B 2307/718; B32B 2317/12; B32B 2439/06

(57) ABSTRACT

A recyclable, paper-based packaging article formed of a laminated web comprises a first paper ply and second ply. A first adhesive layer is disposed between the first paper ply and the second ply, the first adhesive layer securing the first paper ply to the second ply. The first adhesive layer is selectively applied in a predefined pattern to create non-adhesive regions between the first paper ply to the second ply, whereby air gaps are created between the first paper ply to the second ply. The first and second plies are adjoined via the first adhesive layer to form the laminated web. The first paper ply comprises about 80% to about 99% based on the total weight of the laminated web.

### CROSS REFERENCE TO RELATED APPLICATION

This application claims the priority benefit of U.S. provisional application Ser. No. 63/538,543 filed Sep. 15, 2023. The aforementioned application is incorporated herein by reference in its entirety.

### BACKGROUND

The present invention relates to bags or bag-like packaging structures for the storage and transporting of goods and, in particular, to multi-ply, insulated, paper-based bags or bag-like packaging structures that provide a high degree of thermal insulation and are recyclable in paper recycling streams, such as curbside recycling programs.

In recent years, the way consumers shop for groceries and meals has undergone a significant transformation. Convenience is one factor driving this trend. With the convenience of e-commerce, more and more customers are turning to online platforms for the purchase of food-related products. Online grocery shopping allows consumers to browse a wide variety of products and have their groceries delivered to their doorstep. Similarly, meal delivery services and pre-packaged meal kits have also gained in popularity in recent years.

The COVID-19 pandemic also accelerated the adoption of online grocery shopping. Concerns about safety and social distancing prompted many consumers to explore e-commerce alternatives. This shift is likely to remain a permanent part of consumers' shopping habits.

Online grocery and meal shopping aligns in some respects with growing environmental concerns about sustainability. For example, online shopping allows consumers to access a wider range of products, including organic items, eco-friendly products, and the like. Online shopping can also reduce the need for individual car trips to the store, potentially lowering carbon footprints.

However, the increase in online food shopping comes with certain challenges and sustainability concerns. One challenge resides in the handling of non-pantry items, particularly frozen and perishable goods. Keeping such temperature-sensitive items cold during the shopping and delivery process, which can sometimes take one to two hours or more, poses a significant hurdle. Many online food delivery services rely on non-recyclable foil-lined insulated packaging. However, such packaging is often disposed of after a single use, which can lead to an increase in waste and environmental impact.

Therefore, what is needed is a paper-based bag or bag-like structure with sufficient thermal insulating properties for use with temperature-sensitive goods, especially frozen or perishable goods ordered via online grocery delivery platforms, and that is also recyclable through curbside recycling programs or other paper recycling streams. The present disclosure contemplates new and improved recyclable, thermally insulating paper-based bag-type structures and laminated webs therefore which overcome the above-referenced problems and others.

### SUMMARY

In one aspect, a recyclable, paper-based packaging article formed of a laminated web comprises a first paper ply and a second ply. A first adhesive layer is disposed between the first paper ply and the second ply, the first adhesive layer securing the first paper ply to the second ply. The first adhesive layer is selectively applied in a predefined pattern to create non-adhesive regions between the first paper ply and the second ply, whereby air gaps are created between the first paper ply and the second ply. The first paper ply and the second ply are adjoined via the first layer to form the laminated web.

In a more limited aspect, the first paper ply comprises about 80% to about 99% based on the total weight of the laminated web.

In another more limited aspect, the first adhesive layer covers about 5% to 99% of the total surface area of the laminated web.

In another more limited aspect, the first adhesive layer covers about 30% to 80% of the total surface area of the laminated web.

In another more limited aspect, the first adhesive layer covers about 40% to 70% of the total surface area of the laminated web.

In another more limited aspect, the second ply comprises a polymer film layer, wherein the polymer film layer is formed of a polymer material selected from the group consisting of polyester, polyethylene terephthalate (PET), polyolefin, polyethylene (PE), polypropylene (PP), oriented polypropylene (OPP), uniaxially-oriented polypropylene (UOPP), biaxially oriented polypropylene (BOPP), polyamide, nylon, nylon 6, nylon 66, nylon 11, nylon 12, nylon 610, nylon blends, biaxially oriented nylon (BON), cast nylon film, blown nylon film, polylactic acid (PLA), polyhydroxyalkanoate (PHA), polybutylene succinate (PBS), polycaprolactone (PCL), poly-3-hydroxybutyrate (P3HB), poly-4-hydroxybutyrate (P4HB), thermoplastic starch (TPS), polybutylene adipate terephthalate (PBAT), PE-based extrusion lamination, and polypropylene-based extrusion lamination, and blends thereof.

In another more limited aspect, the polymer film layer has a thickness in the range of 7 microns to 50 microns.

In another more limited aspect, the polymer film layer has a thickness in the range of 12 microns to 30 microns.

In another more limited aspect, the polymer film layer has a thickness in the range of 12 microns to 20 microns.

In a still more limited aspect, the polymer material of the polymer film layer comprises a barrier coating selected from the group consisting of aluminum oxide, silicon oxide, and polyvinyl alcohol.

In another more limited aspect, the polymer film layer with the barrier coating has a thickness in the range of 7 microns to 50 microns.

In another more limited aspect, the polymer film layer with the barrier coating has a thickness in the range of 12 microns to 30 microns.

In another more limited aspect, the polymer film layer with the barrier coating has a thickness in the range of 12 microns to 20 microns.

In a still more limited aspect, the polymer film layer further comprises a metallization layer.

In another more limited aspect, the polymer film layer with the metallization layer has a thickness in the range of 7 microns to 50 microns.

In another more limited aspect, the polymer film layer with the metallization layer has a thickness in the range of 12 microns to 30 microns.

In another more limited aspect, the polymer film layer with the metallization layer has a thickness in the range of 12 microns to 20 microns.

In yet another more limited aspect, the metallization layer comprises aluminum.

In another more limited aspect, the metallization layer is applied at a thickness to achieve an optical density of 1 or greater.

In yet another more limited aspect, the metallization layer is applied at a thickness to achieve an optical density in the range of 1.5 to 3.

In another more limited aspect, the metallization layer is applied at a thickness to achieve an optical density of 2.

In another more limited aspect, the second ply is a metal foil.

In yet another more limited aspect, the metal foil comprises aluminum.

In yet another more limited aspect, the metal foil has a thickness in the range of about 7 microns to about 15 microns.

In another more limited aspect, the first paper ply is formed of a paper selected from the group consisting of natural kraft papers, bleached kraft papers, white kraft papers, solid bleached sulfate papers, coated papers, and recycled papers.

In another more limited aspect, the first paper ply is formed of a paper having a basis weight in the range of from about 40#/ream (65.1 g/m²) to about 150#/ream (244.2 g/m²).

In another more limited aspect, the first paper ply is formed of a paper having a basis weight in the range of from about 60#/ream (97.7 g/m²) to about 70#/ream (114.0 g/m²).

In another more limited aspect, the first adhesive layer is selected from the group consisting of solvent-based adhesives, solventless adhesives, water-based adhesives, pressure sensitive adhesives, acrylic-based adhesives, styrene copolymer adhesives, and rubber-based adhesives.

In another more limited aspect, the packaging article further comprises a third paper ply and a second adhesive layer disposed between the third paper ply and the first paper ply, the second adhesive layer securing the third paper ply to the first paper ply, wherein the second adhesive layer is selectively applied in a predefined pattern to create non-adhesive regions between the first paper ply and the third paper ply, whereby air gaps are created between the first paper ply and the third paper ply; wherein the third paper ply, the first paper ply, and the second ply are adjoined via the first and second adhesive layers to form the laminated web; and wherein the first paper ply and the third paper ply taken together comprise about 80% to about 99% of the total weight of the laminated web.

In another more limited aspect, the packaging article further comprises a third paper ply and a second adhesive layer disposed between the third paper ply and the second ply, the second adhesive layer securing the third paper ply to the second ply, wherein the second adhesive layer is selectively applied in a predefined pattern to create non-adhesive regions between the third paper ply and the second ply, whereby air gaps are created between the third paper ply and the second ply; wherein the third paper ply, the first paper ply, and the second ply are adjoined via the first and second adhesive layers to form the laminated web; and wherein the first paper ply and the third paper ply taken together comprise about 80% to about 99% of the total weight of the laminated web.

In another more limited aspect, each of the first and second adhesive layers, which may be the same or different, covers about 5% to 99% of the total surface area of the laminated web.

In another more limited aspect, each of the first and second adhesive layers, which may be the same or different, covers about 30% to 80% of the total surface area of the laminated web.

In another more limited aspect, each of the first and second adhesive layers, which may be the same or different, covers about 40% to 70% of the total surface area of the laminated web.

In another more limited aspect, the second ply comprises a polymer film layer, wherein the polymer film layer is formed of a polymer material selected from the group consisting of polyester, polyethylene terephthalate (PET), polyolefin, polyethylene (PE), polypropylene (PP), oriented polypropylene (OPP), uniaxially-oriented polypropylene (UOPP), biaxially oriented polypropylene (BOPP), polyamide, nylon, nylon 6, nylon 66, nylon 11, nylon 12, nylon 610, nylon blends, biaxially oriented nylon (BON), cast nylon film, blown nylon film, polylactic acid (PLA), polyhydroxyalkanoate (PHA), polybutylene succinate (PBS), polycaprolactone (PCL), poly-3-hydroxybutyrate (P3HB), poly-4-hydroxybutyrate (P4HB), thermoplastic starch (TPS), polybutylene adipate terephthalate (PBAT), PE-based extrusion lamination, and polypropylene-based extrusion lamination, and blends thereof.

In another more limited aspect, the polymer film layer has a thickness in the range of 7 microns to 50 microns.

In another more limited aspect, the polymer film layer has a thickness in the range of 12 microns to 30 microns.

In another more limited aspect, the polymer film layer has a thickness in the range of 12 microns to 20 microns.

In a still more limited aspect, the polymer material of the polymer film layer comprises a barrier coating selected from the group consisting of aluminum oxide, silicon oxide, and polyvinyl alcohol.

In another more limited aspect, the polymer film layer with the barrier coating has a thickness in the range of 7 microns to 50 microns.

In another more limited aspect, the polymer film layer with the barrier coating has a thickness in the range of 12 microns to 30 microns.

In another more limited aspect, the polymer film layer with the barrier coating has a thickness in the range of 12 microns to 20 microns.

In a still more limited aspect, the polymer film layer further comprises a metallization layer.

In another more limited aspect, the polymer film layer with the metallization layer has a thickness in the range of 7 microns to 50 microns.

In another more limited aspect, the polymer film layer with the metallization layer has a thickness in the range of 12 microns to 30 microns.

In another more limited aspect, the polymer film layer with the metallization layer has a thickness in the range of 12 microns to 20 microns.

In yet another more limited aspect, the metallization layer comprises aluminum.

In another more limited aspect, the metallization layer is applied at a thickness to achieve an optical density of 1 or greater.

In yet another more limited aspect, the metallization layer is applied at a thickness to achieve an optical density in the range of 1.5 to 3.

In another more limited aspect, the metallization layer is applied at a thickness to achieve an optical density of 2.

In another more limited aspect, the second ply is a metal foil.

In yet another more limited aspect, the metal foil comprises aluminum.

In yet another more limited aspect, the metal foil has a thickness in the range of about 7 microns to about 15 microns.

In still more limited aspect, the second paper ply is formed of a paper selected from the group consisting of natural kraft papers, bleached kraft papers, white kraft papers, solid bleached sulfate papers, coated papers, and recycled papers.

In another more limited aspect, each of the first and third paper plies, which may be the same or different, is formed of a paper selected from the group consisting of natural kraft papers, bleached kraft papers, white kraft papers, solid bleached sulfate papers, coated papers, and recycled papers.

In another more limited aspect, each of the first and third paper plies, which may be the same or different, is formed of a paper having a basis weight in the range of from about 40#/ream (65.1 g/m²) to about 150#/ream (244.2 g/m²).

In another more limited aspect, each of the first and third paper plies, which may be the same or different, is formed of a paper having a basis weight in the range of from about 60#/ream (97.7 g/m²) to about 70#/ream (114.0 g/m²).

In another more limited aspect, each of the first and second adhesive layers, which may be the same or different, is selected from the group consisting of solvent-based adhesives, solventless adhesives, water-based adhesives, pressure sensitive adhesives, acrylic-based adhesives, styrene copolymer adhesives, and rubber-based adhesives.

In another more limited aspect, the packaging article is a bag defining a bag interior, wherein the inner ply faces the bag interior.

In another more limited aspect, the bag comprises a closed bottom, opposing front and real panels extending from the closed bottom, opposing left and right side panels extending from the closed bottom, wherein the bag is open at the top.

In another more limited aspect, the bag is a self-opening sack (SOS) type bag.

In a further aspect, a method of forming a laminated web for a packaging article includes providing a first web formed of a first paper material and a second web. A first adhesive layer is selectively applied intermediate the first web and the second web in a predefined pattern to create non-adhesive regions between the inner web and the intermediate web. The first and second webs are adhered to form a laminated structure, wherein air gaps are created between the first and second webs. The first web comprises about 80% to about 99% based on the total weight of the laminated web.

In a more limited aspect, the method further includes cutting the laminated web to form a blank and folding the blank along predetermined fold lines to create a partially formed bag. One end of the partially formed bag is closed to create a bag.

In a more limited aspect, the method further includes providing a third web formed of a third paper material and selectively applying a second adhesive layer intermediate the first and third webs a predefined pattern to create non-adhesive regions between the first and third webs. The first, second, and third webs are adhered to form a laminated structure, wherein air gaps are created between the first and second webs and between the first and third webs. The first and third webs taken together comprise about 80% to about 99% based on the total weight of the laminated web.

In a more limited aspect, the method further includes providing a third web formed of a third paper material and selectively applying a second adhesive layer intermediate the second and third webs a predefined pattern to create non-adhesive regions between the second and third webs. The first, second, and third webs are adhered to form a laminated structure, wherein air gaps are created between the first and second webs and between the second and third webs. The first and third webs taken together comprise about 80% to about 99% based on the total weight of the laminated web.

Advantages and benefits of the present disclosure will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings, which are not necessarily to scale, are only for purposes of illustrating preferred embodiments and are not to be construed as limiting the invention.

FIG. 1 is an isometric view of an exemplary insulating, recyclable, paper-based bag structure of the present invention.

FIG. 2 is a cross-sectional view of the packaging structure appearing in FIG. 1.

FIGS. 3A-3E are cross-sectional views of exemplary first embodiment laminated sheet material with two plies which can be used to form the bag or bag-like structures herein.

FIGS. 4A-4B are cross-sectional views of exemplary first embodiment laminated sheet material with three plies which can be used to form the bag or bag-like structures herein.

FIGS. 5A-5C illustrate exemplary process lines for the manufacture of the insulating, recyclable paper-based bag structure appearing in FIG. 1.

### DETAILED DESCRIPTION OF THE PREFERRED EMBODIMENTS

The terms “a” or “an,” as used herein, are defined as one or more than one. The term “another,” as used herein, is defined as at least a second or more. The terms “including” and/or “having” as used herein, are defined as comprising (i.e., open transition). As used herein, the terms “joined,” “coupled,” “operatively coupled,” and the like, are defined as indirectly or directly connected, unless specifically stated otherwise.

As used herein, “paper-based” means a material or structure primarily comprising cellulosic fibers, e.g., derived from wood pulp, and wherein the amount of plastic materials, such as polyethylene, nylon, polypropylene, polyester, and others, are sufficiently low so as not to impede recyclability in paper recycling streams.

As used herein, “recyclable” may refer to a product that is eligible for acceptance into paper recycling programs, including curbside collection programs and recycling programs that use drop-off locations, including products that comply with one or more promulgated standards or guidelines for recyclability, and including materials that are sufficiently free of plastic materials, such as polyethylene, nylon, polypropylene, polyester, and others which would impede recyclability.

As used herein, “repulpable” may refer to a product that can be reused or remade into paper (e.g., at a paper mill), including products that comply with one or more promulgated standards or guidelines for repulpability, and including materials that are sufficiently free of plastic materials, such as polyethylene, nylon, polypropylene, polyester, and others which would impede repulpability.

As used herein, the terms “grease resistant” or “grease resistance” refers to the character of the PVOH barrier layer in blocking or impeding the absorption or transmission of grease or oil in any significant quantity.

All numbers herein are assumed to be modified by the term “about,” unless stated otherwise. The recitation of numerical ranges by endpoints includes all numbers subsumed within that range (e.g., 1 to 5 includes, inter alia, 1, 1.5, 2, 2.75, 3, 3.80, 4, and 5).

Accordingly, unless indicated to the contrary, the numerical parameters set forth in the present specification and attached claims are approximations that can vary depending upon the desired properties sought to be obtained by the presently disclosed subject matter.

As used herein, the term “about,” when referring to a value can encompass variations of, in some embodiments ±20%, in some embodiments ±10%, in some embodiments ±5%, in some embodiments ±1%, in some embodiments ±0.5%, in some embodiments ±0.1%, and in some embodiments to ±0.01%, from the specified amount, as such variations are appropriate in the disclosed materials and methods.

All compositional percentages used herein are presented on a “by weight” basis, unless specifically stated otherwise. All basis weights herein are pounds per 3000 square foot ream unless specifically stated otherwise.

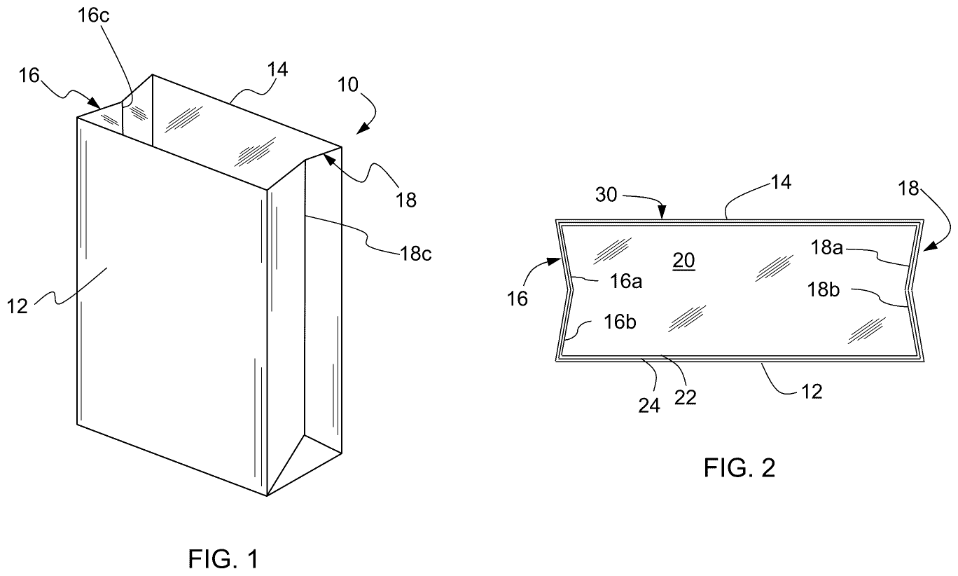

Referring now to the drawings, wherein like reference numerals are used to describe like or analogous items, FIG. 1 illustrates an exemplary bag type packaging structure 10. The structure 10 is illustrated as a self-opening sack (SOS), although it will be recognized other bag or bag-like container configurations can be utilized. The structure 10 includes a pair of generally opposing, rectangular front and back panels 12 and 14, respectively. The front panel 12 and the back panel 14 are joined at opposite edges by gusseted side panels 16 and 18. The packaging structures 10 herein are advantageously used in connection with frozen, cold, or perishable grocery products or other temperature-sensitive items. The packaging structures 10 here may also be used to maintain temperature in connection with hot or warm goods such as food or meals delivered by meal delivery services.

Referring now to FIG. 2, and with continued reference to FIG. 1, the gusseted side panels 16 and 18 comprise first and second panel portions 16a, 16b and 18a, 18b, respectively. The panel portions 16a, 16b and 18a, 18b are joined along respective fold lines 16c and 18c. The folded lines 16c and 18c enable the gusseted side panels 16 and 18 to be folded inwardly with an accordion pleat. When the structure 10 is folded in a collapsed, flat configuration, the gusseted panels 16 and 18 are disposed between the front panel 12 and the back panel 14. The front panel 12, back panel 14, gusseted side panel 16, and gusseted side panel 18 are adhesively secured together to close and seal the bottom end 20 of the bag 10. The panels 12, 14, 16, and 18 of the bag 10 are constructed with a recyclable, insulating, paper-based structure as described below.

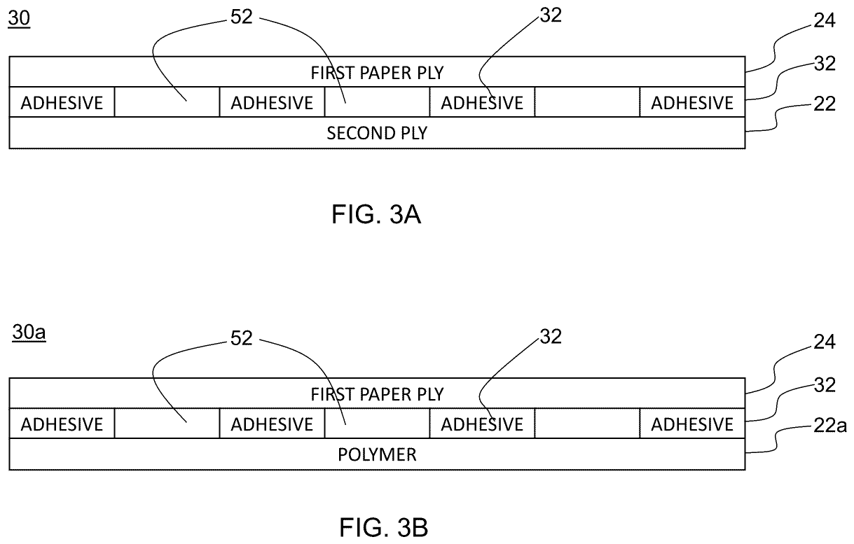

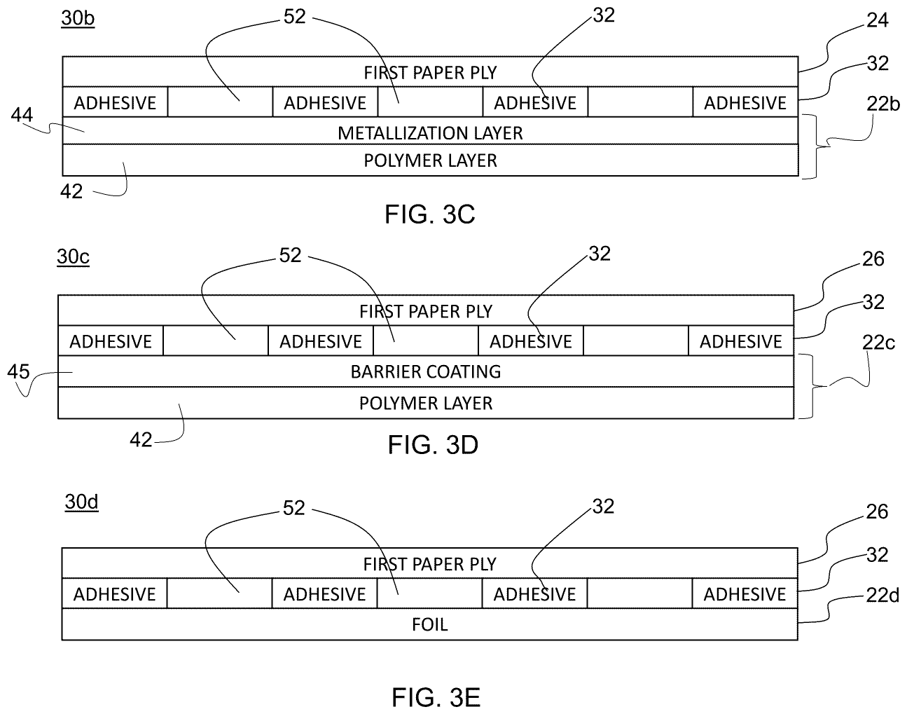

As shown in FIG. 3A, a laminated structure 30 comprises a first paper ply 24 and a second ply 22. A first patterned adhesive layer 32 is disposed between the second ply 22 and the first paper layer 24. In embodiments, the first paper ply 24 comprises at least 80% by weight of the structure 30. In embodiments, the paper ply 24 comprises at least 81% by weight of the structure 30. In certain embodiments, the paper ply 24 comprises at least 82% by weight based on the total weight of the structure 30, e.g., 82%, 83%, 84%, 85%, 86%, 87%, 88%, 89%, 90%, 91%, 92%, 93%, 94%, 95%, 96%, 97%, 98%, or 99%.

As shown in FIGS. 3B-3E, various embodiments of second ply 22 are provided. In laminated structure 30a, shown in FIG. 3B, second ply 22 is a polymer layer 22a. In laminated structure 30b, shown in FIG. 3C, second ply 22 is a metallized polymer film layer 22b comprising a polymer layer 42 and a metallization layer 44. In laminated structure 30c, shown in FIG. 3D, second ply 22 is a coated polymer film 22c comprising a polymer layer 42 and a barrier coating 45. In laminated structure 30d, shown in FIG. 3E, second ply 22 is a foil 22d.

The polymer layer 22a (FIG. 3B) or 42 (FIGS. 3C and 3D) may be any suitable polymer film, including without limitation polyethylene terephthalate (PET), oriented polypropylene (OPP), unilaterally-oriented polypropylene (UOPP), biaxially oriented polypropylene (BOPP), polyethylene (PE). In embodiments, the polymer layer 42 is formed of a biodegradable or compostable polymer, such as polylactic acid (PLA), polyhydroxyalkanoate (PHA), polybutylene succinate (PBS), polycaprolactone (PCL), poly-3-hydroxybutyrate (P3HB), poly-4-hydroxybutyrate (P4HB), thermoplastic starch (TPS), polybutylene adipate terephthalate (PBAT), PE-based extrusion lamination, and polypropylene-based extrusion lamination, and blends thereof. A PE-based extrusion lamination is understood to be a film structure with PE on either side of ethylene vinyl alcohol (PE-EVOH-PE). A polypropylene-based extrusion lamination is understood to be a film structure with polypropylene on either side of ethylene vinyl alcohol (PP-EVOH-PP). In embodiments, the polymer layer 22a has a thickness in the range of 7 microns to 50 microns. In embodiments, the polymer layer 22a has a thickness in the range of 12 microns to 30 microns. In embodiments, the polymer layer 22a has a thickness in the range of 12 microns to 20 microns.

The metallization layer 44 of the metallized polymer film layer 22b (FIG. 3C) is formed of a metal. In embodiments, the metallization layer is formed of aluminum. In embodiments, the metallization layer is formed via a deposition process on the polymer layer 42 such as sputter deposition (including magnetron or ion beam sputter deposition), thermal evaporation physical vapor deposition, and chemical vapor deposition. In embodiments, the metallization layer is applied at a thickness to achieve an optical density of 1 or greater. In embodiments, the metallization layer is applied at a thickness to achieve an optical density in the range of 1.5 to 3. In embodiments, the metallization layer is applied at a thickness to achieve an optical density of 2. Although metallization layer 44 is shown between polymer layer 42 and first patterned adhesive layer 32 in FIG. 3C, in embodiments, the metallization layer 44 and the polymer layer 42 are reversed so that the polymer layer 42 is between the metallization layer 44 and the first patterned adhesive layer 32.

In embodiments, the metallized polymer film layer 22b has a thickness in the range of 7 microns to 50 microns. In embodiments, the metallized polymer film layer 22b has a thickness in the range of 12 microns to 30 microns. In embodiments, the metallized polymer film layer 22b has a thickness in the range of 12 microns to 20 microns.

In embodiments, the barrier coating 45 of the coated polymer film 22c (FIG. 3D) is formed of silicon oxide (SiOx), aluminum oxide (AlOx), or polyvinyl alcohol (PVOH). Although barrier coating 45 is shown between polymer layer 42 and first patterned adhesive layer 32 in FIG. 3D, in embodiments, the barrier coating 45 and the polymer layer 42 are reversed so that the polymer layer 42 is between the barrier coating 45 and the first patterned adhesive layer 32. In embodiments, the coated polymer film 22c has a thickness in the range of 7 microns to 50 microns. In embodiments, the coated polymer film 22c has a thickness in the range of 12 microns to 30 microns. In embodiments, the coated polymer film 22c has a thickness in the range of 12 microns to 20 microns.

In embodiments, the foil layer 22d (FIG. 3E) has a thickness in the range of 7 microns to 15 microns, preferably 12 microns. In embodiments, the foil layer 22d is aluminum.

In embodiments, the first paper ply 24 is formed of a paper having a basis weight in the range of 40#/ream (65.1 g/m²) to 150#/ream (244.2 g/m²), preferably, 60#/ream (97.7 g/m²) to 70#/ream (114.0 g/m²), and most preferably 70#/ream (114.0 g/m²). In embodiments, the first paper layer 24 is formed of a paper such as natural kraft papers, bleached kraft papers, white kraft papers, solid bleached sulfate papers, coated papers, recycled papers, and the like. In embodiments, the first paper layer ply 24 is grease resistant.

In embodiments, the first adhesive layer 32 is formed of any suitable adhesive for adhering the plies, including without limitation, solvent-based adhesives, solventless adhesives, water-based adhesives, pressure sensitive adhesives, acrylic-based adhesives, styrene copolymer adhesives, rubber-based adhesives, and others as would be understood by persons skilled in the art.

The patterned adhesive layer 32 is applied in a first pattern which is intended to create voids or air pockets 52 between the second ply 22 (e.g., 22a, 22b, 22c, or 22d, shown in FIGS. 3B-3E, respectively) and the first paper layer 24. The air gaps 52 serve to increase the thermal insulating properties of the structure 30 (e.g., 30a, 30b, 30c, or 30d, shown in FIGS. 3B-3E, respectively) and the resulting bag structure 10.

In embodiments, the first pattern adhesive layer 32 may be applied in a stripe pattern although other patterns are contemplated, such as wavy line patterns, intersecting patterns such as grid patterns and weave-like patterns, dot patterns, segmented or broken line patterns, and so forth. In certain embodiments, the first patterned adhesive layer 32 comprises parallel lines of adhesive which extend in the machine direction. In certain embodiments, the first patterned adhesive layer 32 comprises parallel lines of adhesive which extend in the transverse direction.

The first patterned adhesive layer 32 only partially covers the underlying layer to which it is applied. In embodiments, the coverage of the patterned adhesive layer 32 ranges from 5% to 99% of the total surface area of the laminate. In embodiments, the coverage of the first patterned adhesive layer 32 ranges from 30% to 80%. In embodiments, the coverage of the first patterned adhesive layer 32 ranges from 40% to 70%. The percent coverage of the first patterned adhesive layer 32 provided herein refers to the area coverage of the adhesive layer “as applied,” that is, after the adhesive has been applied but before lamination or bonding the layers together, i.e., before any compression or squeezing occurs during the lamination process.

The first patterned adhesive layers 32 can be applied using any suitable method. Examples include roll coating with a patterned roller, gravure roll coating, flexographic printing, slot die coating, screen printing, patterned spray coating, and inkjet printing, among others.

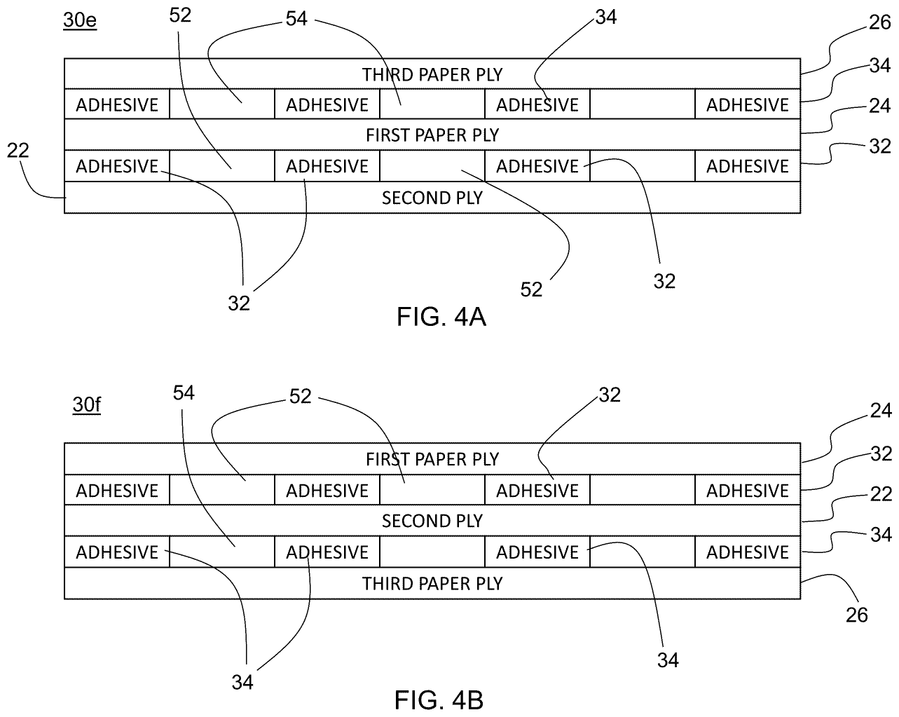

Now referring to FIGS. 4A and 4B, exemplary embodiments of structure 30 including a third paper ply 26 and a second patterned adhesive layer 34 are provided. As shown in FIG. 4A, structure 30e includes second patterned adhesive layer 34 between the first and third paper plies 24, 26, so that the third paper ply 26 and the second ply 22 are the outer layers of structure 30e. As shown in FIG. 4B, structure 30f includes second patterned adhesive layer 34 between the second ply 22 and the third paper ply 26, so that the first and third paper plies 24, 26 are the outer layers of structure 30f. In embodiments, the paper plies 24, 26 together comprise at least 80% by weight of either of the structures 30e, 30f. In embodiments, the first and third paper plies 24, 26 together comprise at least 81% by weight of either of the structures 30e, 30f. In certain embodiments, the paper plies 24, 26 together comprise at least 82% by weight based on the total weight of either of the structures 30e, 30f, e.g., 82%, 83%, 84%, 85%, 86%, 87%, 88%, 89%, 90%, 91%, 92%, 93%, 94%, 95%, 96%, 97%, 98%, or 99%.

In embodiments of structures 30e and 30f, the second ply 22 is as described in any of FIGS. 3B-3E. Specifically, in embodiments, the second ply 22 is a polymer layer 22a (as in FIG. 3B). In embodiments, the second ply 22 is a metallized polymer film layer 22b (as in FIG. 3C), comprising a metallization layer 44 and a polymer layer 42. In embodiments, the second ply 22 is a coated polymer film 22c (as in FIG. 3D), comprising a barrier coating 45 and a polymer layer 42. In embodiments, the second ply 22 is a foil 22d (as in FIG. 3E).

In embodiments, the first and third paper layers 24 and 26, which may be the same or different, are formed of a paper having a basis weight in the range of 40#/ream (65.1 g/m²) to 150#/ream (244.2 g/m²), preferably, 60#/ream (97.7 g/m²) to 70#/ream (114.0 g/m²), and most preferably 70#/ream (114.0 g/m²). In embodiments, the paper layers 24 and 26 are formed of a paper such as natural kraft papers, bleached kraft papers, white kraft papers, solid bleached sulfate papers, coated papers, recycled papers, and the like. In embodiments, the first paper ply 24 and/or the third paper ply 26 are grease resistant.

In embodiments, the first and second patterned adhesive layers 32 and 34, which may be the same or different, are formed of any suitable adhesive for adhering the plies, including without limitation, solvent-based adhesives, solventless adhesives, water-based adhesives, pressure sensitive adhesives, acrylic-based adhesives, styrene copolymer adhesives, rubber-based adhesives, and others as would be understood by persons skilled in the art.

The first patterned adhesive layer 32 is applied in a first pattern which is intended to create voids or air pockets 52 between the first paper ply 24 and the second ply 22, whether the first paper ply 24 is an intermediate layer (FIG. 4A) of structure 30e or an outer layer (FIG. 4B) of structure 30f. The air gaps 52 serve to increase the thermal insulating properties of the structure 30e, 30f and the resulting bag structure 10.

The second patterned adhesive layer 34 is applied in a first pattern which is intended to create voids or air pockets 54 between the third paper ply 26 and the first paper ply 24 (FIG. 4A) of structure 30e or between the third paper ply 26 and the second ply 22 (FIG. 4B) of structure 30f. The air gaps 54 serve to increase the thermal insulating properties of the structure 30e, 30f and the resulting bag structure 10.

In embodiments, the first and second pattern adhesive layers 32, 34, which may be the same or different, may be applied in a stripe pattern although other patterns are contemplated, such as wavy line patterns, intersecting patterns such as grid patterns and weave-like patterns, dot patterns, segmented or broken line patterns, and so forth. In certain embodiments, the patterned adhesive layers 32, 34 comprise parallel lines of adhesive which extend in the machine direction. In certain embodiments, the patterned adhesive layers 32, 34 comprise parallel lines of adhesive which extend in the transverse direction.

Each of the patterned adhesive layers 32, 34, which may be the same or different, only partially covers the underlying layer to which it is applied. In embodiments, the coverage of the patterned adhesive layers 32, 34 ranges from 5% to 99% of the total surface area of the laminate 30. In embodiments, the coverage of the patterned adhesive layers 32, 34 ranges from 30% to 80%. In embodiments, the coverage of the patterned adhesive layers 32, 34 ranges from 40% to 70%. The percent coverage of the patterned adhesive layers 32, 34 provided herein refers to the area coverage of the adhesive layer “as applied,” that is, after the adhesive has been applied but before lamination or bonding the layers together, i.e., before any compression or squeezing occurs during the lamination process.

The patterned adhesive layers 32, 34 can be applied using any suitable method. Examples include roll coating with a patterned roller, gravure roll coating, flexographic printing, slot die coating, screen printing, patterned spray coating, and inkjet printing, among others.

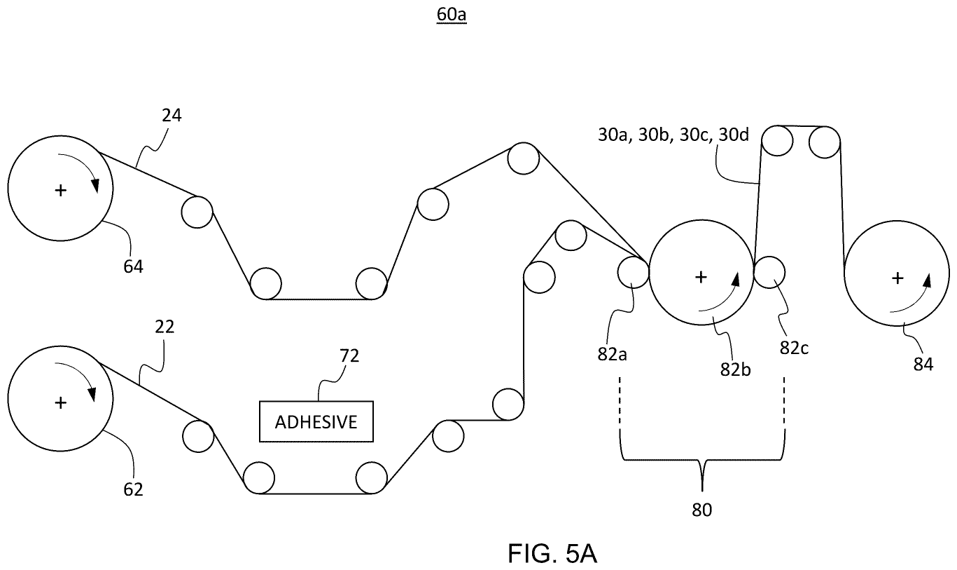

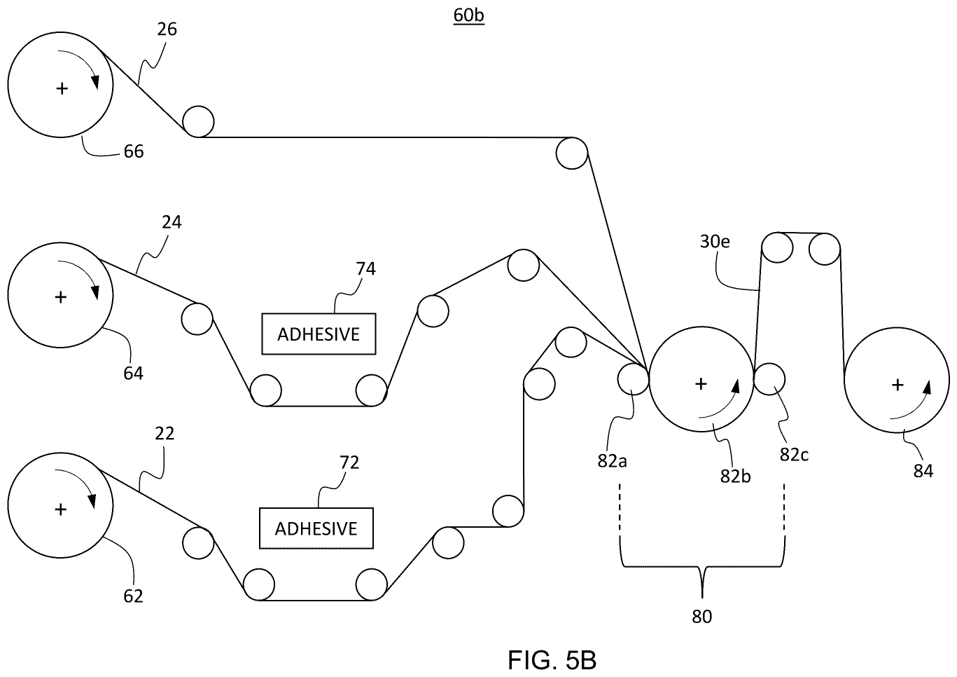

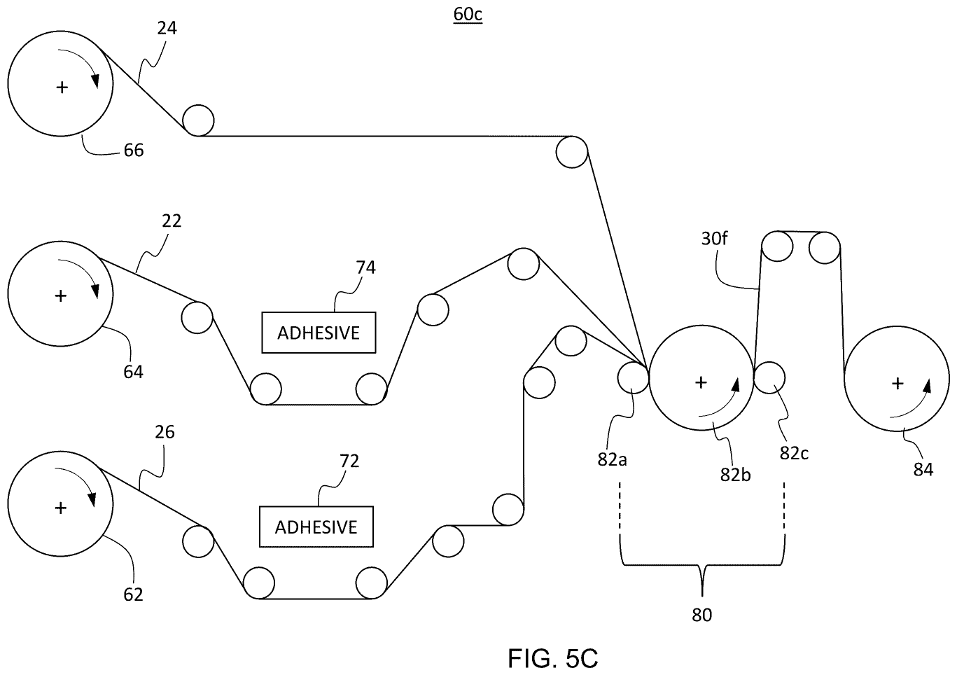

Referring now to FIG. 5A, an exemplary process line 60a is shown for the manufacture of the paper-based recyclable insulated bags in accordance with the present disclosure. The first paper ply 24 and the second ply 22 (e.g., 22a, 22b, 22c, 22d) are separate webs which are adhered together to form a multilayer web 30 (e.g., 30a, 30b, 30c, 30d).

The second ply 22 is fed from a feed roll 62 toward a pattern adhesive coater 72. The first paper ply 24 is fed from a feed roll 64 toward an adhesive laminating station 80 comprising a series of laminating rollers 82a, 82b, and 82c.

The pattern adhesive coated second ply 22 and the first paper layer 24 come together and pass through the rollers 82a, 82b, 82c, that apply pressure to bond the plies together for forming the film structure 30. In embodiments, the rollers 82a, 82b, 82c are heated to activate the adhesive and ensure a strong bond. The laminated film structure 30 (e.g., 30a, 30b, 30c, 30d) is then wound onto a finished product roll 84. Optionally, a dryer (not shown), e.g., comprising a series of rollers and a heat source, may be provided between the adhesive laminating station 80 and the take up roll 84.

In the manufacture of the bag construction 10, after the plies 22 and 24 are adhered to form the multi-ply web 30a, 30b, 30c, 30d, the web 30a, 30b, 30c, 30d can be printed, cut, folded, and adhered to form the bag 10.

Referring now to FIG. 5B, an exemplary process line 60b is shown for the manufacture of the paper-based recyclable insulated bags in accordance with the present disclosure. Process line 60b illustrates a process for manufacturing structure 30e (FIG. 4A), including a third paper ply 26 and second patterned adhesive layer 34, where the third paper ply 26 and the second ply 22 are the outer layers of structure 30e. The plies 22 (e.g., 22a, 22b, 22c, 22d), 24, and 26 are separate webs which are adhered together to form a multilayer web 30e.

The second ply 22 is fed from a feed roll 62 toward a pattern adhesive coater 72. The first paper layer 24 is fed from a feed roll 64 toward a pattern adhesive coater 74. The third paper layer 26 is fed from a feed roll 66 toward an adhesive laminating station 80 comprising a series of laminating rollers 82a, 82b, and 82c.

The pattern adhesive coated second ply 22, the pattern adhesive coated first paper layer 24 and the third paper layer 26 come together and pass through the rollers 82a, 82b, 82c, that apply pressure to bond the plies together for forming the film structure 30e. In embodiments, the rollers 82a, 82b, 82c are heated to activate the adhesive and ensure a strong bond. The laminated film structure 30e is then wound onto a finished product roll 84. Optionally, a dryer (not shown), e.g., comprising a series of rollers and a heat source, may be provided between the adhesive laminating station 80 and the take up roll 84.

In the manufacture of the bag construction 10, after the plies 22, 24, and 26 are adhered to form the multi-ply web 30f, the web 30f can be printed, cut, folded, and adhered to form the bag 10.

Referring now to FIG. 5C, an exemplary process line 60c is shown for the manufacture of the paper-based recyclable insulated bags in accordance with the present disclosure. Process line 60c illustrates a process for manufacturing structure 30f (FIG. 4B), including a third paper ply 26 and second patterned adhesive layer 34, where the first paper ply 24 and the third paper ply 26 are the outer layers of structure 30f. The plies 24, 22 (e.g., 22a, 22b, 22c, 22d, 22e), and 26 are separate webs which are adhered together to form a multilayer web 30f.

The third paper ply 26 is fed from a feed roll 62 toward a pattern adhesive coater 72. The second ply 22 is fed from a feed roll 64 toward a pattern adhesive coater 74. The first paper layer 24 is fed from a feed roll 66 toward an adhesive laminating station 80 comprising a series of laminating rollers 82a, 82b, and 82c.

The pattern adhesive coated third paper layer 26, the pattern adhesive coated second ply 22, and the first paper layer 24 come together and pass through the rollers 82a, 82b, 82c, that apply pressure to bond the plies together for forming the film structure 30f. In embodiments, the rollers 82a, 82b, 82c are heated to activate the adhesive and ensure a strong bond. The laminated film structure 30f is then wound onto a finished product roll 84. Optionally, a dryer (not shown), e.g., comprising a series of rollers and a heat source, may be provided between the adhesive laminating station 80 and the take up roll 84.

In the manufacture of the bag construction 10, after the plies 22, 24, and 26 are adhered to form the multi-ply web 30f, the web 30f can be printed, cut, folded, and adhered to form the bag 10.

The invention has been described with reference to the preferred embodiment. Modifications and alterations will occur to others upon a reading and understanding of the preceding detailed description. It is intended that the invention be construed as including all such modifications and alterations insofar as they come within the scope of the appended claims or the equivalents thereof.

What is claimed is:

1. A recyclable, paper-based packaging article formed of a laminated web, comprising:
a first paper ply;
a second ply; and
a first adhesive layer disposed between the first paper ply and the second ply, the first adhesive layer securing the first paper ply and the second ply, wherein the first adhesive layer is selectively applied in a predefined pattern to create non-adhesive regions between the first paper ply and the second ply, whereby air gaps are created between the first paper ply and the second ply;
wherein the first paper ply and the second ply are adjoined via the first adhesive layer to form the laminated web.

2. The recyclable, paper-based packaging article of claim 1, wherein the first paper ply comprises about 80% to about 99% of the total weight of the laminated web.

3. The recyclable, paper-based packaging article of claim 1, wherein the second ply comprises a polymer film layer formed of a polymer material selected from the group consisting of polyethylene terephthalate (PET), oriented polypropylene (OPP), unilaterally-oriented polypropylene (UOPP), biaxially oriented polypropylene (BOPP), polyethylene (PE), polylactic acid (PLA), polyhydroxyalkanoate (PHA), polybutylene succinate (PBS), polycaprolactone (PCL), poly-3-hydroxybutyrate (P3HB), poly-4-hydroxybutyrate (P4HB), thermoplastic starch (TPS), polybutylene adipate terephthalate (PBAT), PE-based extrusion lamination, and polypropylene-based extrusion lamination, and blends thereof.

4. The recyclable, paper-based packaging article of claim 3, wherein the polymer material of the polymer film layer of the second ply comprises a barrier coating selected from the group consisting of aluminum oxide, silicon oxide, and polyvinyl alcohol.

5. The recyclable, paper-based packaging article of claim 3, wherein the second ply further comprises a metallization layer.

6. The recyclable, paper-based packaging article of claim 1, wherein the second ply is a metal foil.

7. The recyclable, paper-based packaging article of claim 1, further comprising:
a third paper ply; and
a second adhesive layer disposed between the third paper ply and the first paper ply, the second adhesive layer securing the third paper ply to the first paper ply, wherein the second adhesive layer is selectively applied in a predefined pattern to create non-adhesive regions between the first paper ply and the third paper ply, whereby air gaps are created between the first paper ply and the third paper ply;
wherein the third paper ply, the first paper ply, and the second ply are adjoined via the first and second adhesive layers to form the laminated web; and
wherein the first paper ply and the third paper ply taken together comprise about 80% to about 99% of the total weight of the laminated web.

8. The recyclable, paper-based packaging article of claim 7, wherein the third paper ply, which may be the same or different from the first paper ply, is formed of a paper having a basis weight in the range of from about 40#/ream (65 g/m2) to about 150#/ream (244.2 g/m2).

9. The recyclable, paper-based packaging article of claim 7, wherein the second ply comprises a polymer film layer formed of a polymer material selected from the group consisting of polyethylene terephthalate (PET), oriented polypropylene (OPP), unilaterally-oriented polypropylene (UOPP), biaxially oriented polypropylene (BOPP), polyethylene (PE), polylactic acid (PLA), polyhydroxyalkanoate (PHA), polybutylene succinate (PBS), polycaprolactone (PCL), poly-3-hydroxybutyrate (P3HB), poly-4-hydroxybutyrate (P4HB), thermoplastic starch (TPS), polybutylene adipate terephthalate (PBAT), PE-based extrusion lamination, and polypropylene-based extrusion lamination, and blends thereof.

10. The recyclable, paper-based packaging article of claim 9, wherein the polymer material of the polymer film layer of the inner ply comprises a barrier coating selected from the group consisting of aluminum oxide, silicon oxide, and polyvinyl alcohol.

11. The recyclable, paper-based packaging article of claim 9, wherein the second ply further comprises a metallization layer.

12. The recyclable, paper-based packaging article of claim 7, wherein the second ply is a metal foil.

13. The recyclable, paper-based packaging article of claim 1, further comprising:
a third paper ply; and
a second adhesive layer disposed between the third paper ply and the second ply, the second adhesive layer securing the third paper ply to the second ply, wherein the second adhesive layer is selectively applied in a predefined pattern to create non-adhesive regions between the third paper ply and the second ply, whereby air gaps are created between the third paper ply and the second ply;
wherein the first paper ply, the second ply, and the third paper ply are adjoined via the first and second adhesive layers to form the laminated web; and
wherein the first paper ply and the third paper ply taken together comprise about 80% to about 99% of the total weight of the laminated web.

14. The recyclable, paper-based packaging article of claim 13, wherein the third paper ply, which may be the same or different from the first paper ply, is formed of a paper having a basis weight in the range of from about 40#/ream (65 g/m2) to about 150#/ream (244.2 g/m2).

15. The recyclable, paper-based packaging article of claim 13, wherein the second ply comprises a polymer film layer formed of a polymer material selected from the group consisting of polyethylene terephthalate (PET), oriented polypropylene (OPP), unilaterally-oriented polypropylene (UOPP), biaxially oriented polypropylene (BOPP), polyethylene (PE), polylactic acid (PLA), polyhydroxyalkanoate (PHA), polybutylene succinate (PBS), polycaprolactone (PCL), poly-3-hydroxybutyrate (P3HB), poly-4-hydroxybutyrate (P4HB), thermoplastic starch (TPS), polybutylene adipate terephthalate (PBAT), PE-based extrusion lamination, and polypropylene-based extrusion lamination, and blends thereof.

16. The recyclable, paper-based packaging article of claim 15, wherein the polymer material of the polymer film layer of the inner ply comprises a barrier coating selected from the group consisting of aluminum oxide, silicon oxide, and polyvinyl alcohol.

17. The recyclable, paper-based packaging article of claim 15, wherein the second ply further comprises a metallization layer.

18. The recyclable, paper-based packaging article of claim 13, wherein the second ply is a metal foil.

19. The recyclable, paper-based packaging article of claim 1, wherein the first paper ply is formed of a paper having a basis weight in the range of from about 40#/ream (65 g/m2) to about 150#/ream (244.2 g/m2).

20. The recyclable, paper-based packaging article of claim 1, wherein the packaging article is a bag defining a bag interior, wherein the inner ply faces the bag interior.

21. The recyclable, paper-based packaging article of claim 20, wherein the bag comprises a closed bottom, opposing front and real panels extending from the closed bottom, opposing left and right side panels extending from the closed bottom, wherein the bag is open at the top.

22. The paper-based packaging article as recited in claim 1, wherein the bag is a self-opening sack (SOS) type bag.

23. A method of forming a laminated web for a packaging article, comprising:
providing first web formed of a first paper material;
providing a second web;
selectively applying a first adhesive layer intermediate the first web and the second web in a predefined pattern to create non-adhesive regions between the first web and the second web; and
adhering the first and second web to form a laminated structure, wherein air gaps are created between the first and second web.

24. The method of claim 23, further comprising:
cutting the laminated web to form a blank;
folding the blank along predetermined fold lines to create a partially formed bag; and
closing one end of the partially formed bag to create a bag.

25. The method of claim 23, further comprising:
providing a third web formed of a third paper material; and
selectively applying a second adhesive layer intermediate the first and third webs a predefined pattern to create non-adhesive regions between the first and third webs;
wherein the step of adhering the first and second web to form a laminated structure, wherein air gaps are created between the first and second webs, comprises adhering the first, second, and third webs to form the laminated structure, wherein air gaps are further created between the first and third webs; and
wherein the first and third webs taken together comprise about 80% to about 99% based on the total weight of the laminated web.

26. The method of claim 23, further comprising:
providing a third web formed of a third paper material; and
selectively applying a second adhesive layer intermediate the second and third webs a predefined pattern to create non-adhesive regions between the second and third webs;
wherein the step of adhering the first and second web to form a laminated structure, wherein air gaps are created between the first and second webs, comprises adhering the first, second, and third webs to form the laminated structure, wherein air gaps are further created between the second and third webs; and
wherein the first and third webs taken together comprise about 80% to about 99% based on the total weight of the laminated web.
